(19) United States
(12) Patent Application Publication
(10) Pub. No.: US 2010/0128485 A1
(43) Pub. Date: May 27, 2010

(54) CUSTOM ASSEMBLY LIGHT-EMITTING MODULE

(75) Inventors: CHIEN-CHEN TENG, KEELUNG CITY (TW); FANG-PO WANG, TAIPEI COUNTY (TW); WEN-CHIEH CHANG CHIEN, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: LEDTECH ELECTRONICS CORP., TAIPEI COUNTY (TW)

(21) Appl. No.: 12/697,567

(22) Filed: Feb. 1, 2010

Related U.S. Application Data
(63) Continuation-in-part of application No. 12/219,459, filed on Jul. 23, 2008.

(51) Int. Cl. F21V 29/00

(52) U.S. Cl. 362/294

(57) ABSTRACT

A custom assembly light-emitting module includes a base unit, a light-emitting unit and a lens unit. The base unit has a heat-dissipating base and two first retaining structures extending upwards from two opposite lateral sides of the heat-dissipating base. The light-emitting unit is detachably disposed on the heat-dissipating base. The lens unit has a lens and two second retaining structures formed on two opposite lateral sides of the lens, wherein the lens unit is detachably disposed over the light-emitting unit by matching the two first retaining structures and the two second retaining structures. Hence, the base unit, the light-emitting unit and the lens unit can be replaced according to the user's different requirements.

### CROSS REFERENCE TO RELATED APPLICATION

This application is a continuation-in-part of U.S. application Ser. No. 12/219,459, filed on 23 Jul. 2008 and entitled “custom assembly light-emitting module”, now pending.

### BACKGROUND OF THE INVENTION

1. Field of the Invention

The present invention relates to a light-emitting module, and particularly relates to a custom assembly light-emitting module having a heat-dissipating base, a light-emitting element and a lens all of which are replaceable according to user requirements.

2. Description of the Related Art

A traditional light-emitting device is used to provide illumination for humans, such as simple illumination or illumination for enhancing the aspect of the environment. However, the standard of the traditional light-emitting device is fixed such as fixed heat-dissipating effect, fixed light-emitting effect, and fixed light-projecting angle.

When the user purchases the traditional light-emitting device, the components of the traditional light-emitting device cannot be replaced. In other words, because the standard of the traditional light-emitting device is fixed, the components of the traditional light-emitting device cannot be replaced according to the user's different requirements.

### SUMMARY OF THE INVENTION

One particular aspect of the present invention is to provide a custom assembly light-emitting module that includes a base unit, a light-emitting unit and a lens unit that are replaceable according to the user's different requirements. Hence, the base unit is replaceable according to different heat-dissipating effects, the light-emitting unit is replaceable according to different light-emitting effects, and the lens unit is replaceable according to different light-projecting angles.

In order to achieve the above-mentioned aspects, the present invention provides a custom assembly light-emitting module, including: a base unit, a light-emitting unit and a lens unit. The base unit has a heat-dissipating base and two first retaining structures formed on two opposite lateral sides of the heat-dissipating base. The light-emitting unit is detachably disposed on the heat-dissipating base. The lens unit has a lens and two second retaining structures extending downwards from two opposite lateral sides of the lens, wherein the lens unit is detachably disposed over the light-emitting unit by matching the two first retaining structures and the two second retaining structures.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1A is a perspective, exploded view of a custom assembly light-emitting module according to the first embodiment of the present invention;

FIG. 1B is a perspective, assembled view of a custom assembly light-emitting module when a cover unit opening according to the first embodiment of the present invention;

FIG. 1C is a lateral, schematic view of a custom assembly light-emitting module without the cover unit according to the first embodiment of the present invention;

FIG. 1D is a lateral, schematic view of a custom assembly light-emitting module fixed by a hooking unit according to the first embodiment of the present invention;

FIG. 1E is a lateral, schematic view of a custom assembly light-emitting module using another type of lens unit according to the first embodiment of the present invention;

FIG. 2A is a perspective, exploded view of a custom assembly light-emitting module according to the second embodiment of the present invention;

FIG. 2B is a perspective, assembled view of a custom assembly light-emitting module when a cover unit opening according to the second embodiment of the present invention;

FIG. 2C is a lateral, schematic view of a custom assembly light-emitting module without the cover unit according to the second embodiment of the present invention;

FIG. 2D is a lateral, schematic view of a custom assembly light-emitting module fixed by a hooking unit according to the second embodiment of the present invention; and

FIG. 3 is a lateral, schematic view of a custom assembly light-emitting module without the cover unit according to another embodiment of the present invention.

### DETAILED DESCRIPTION OF THE PREFERRED EMBODIMENTS

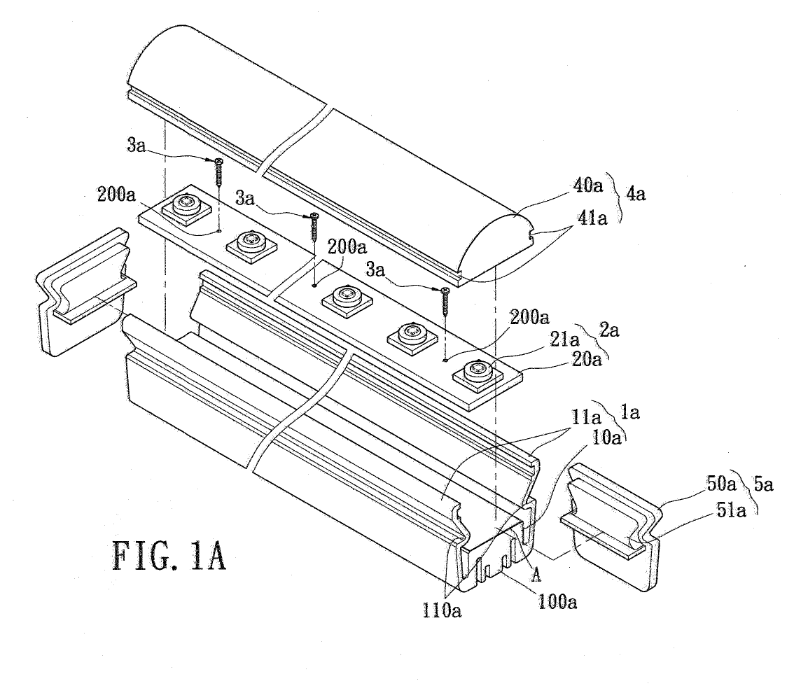

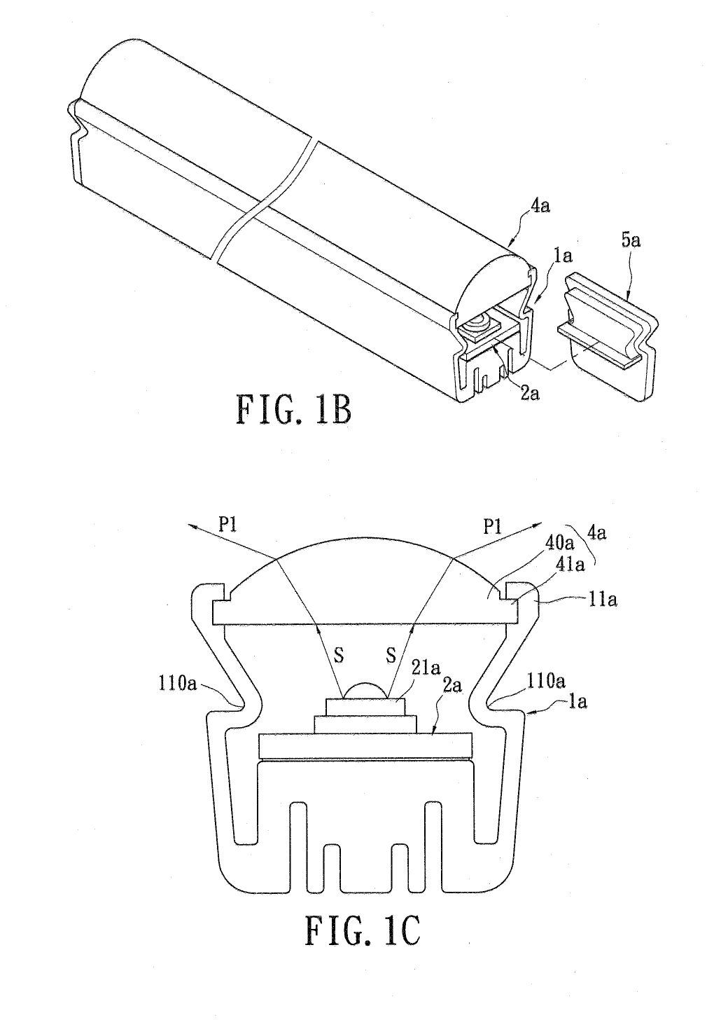

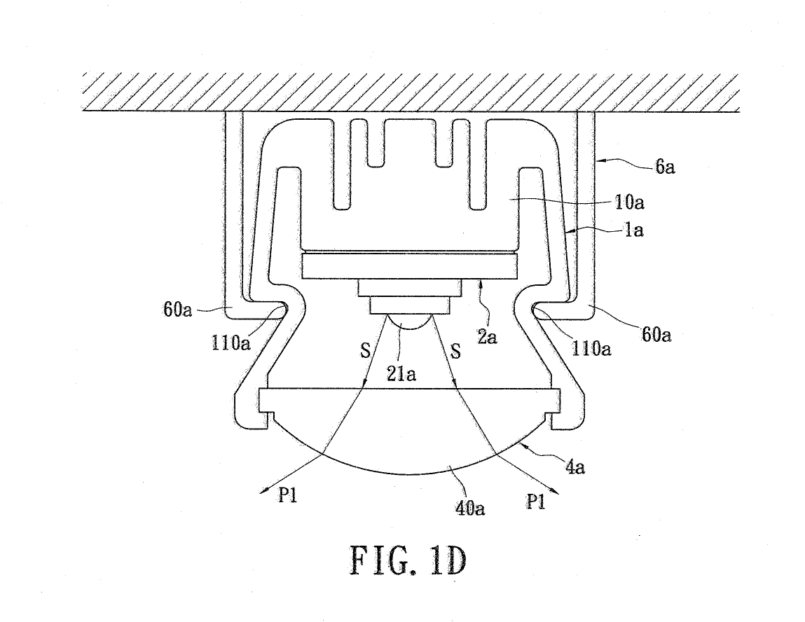

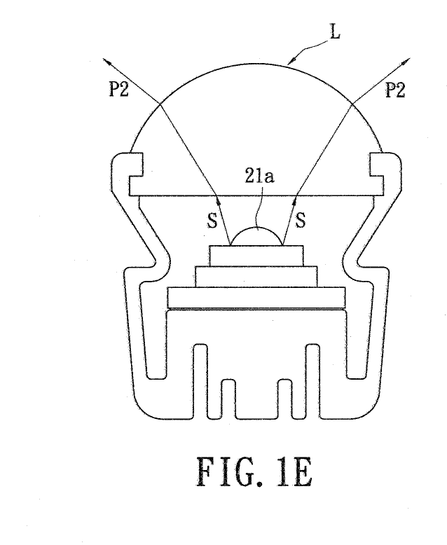

Referring to FIGS. 1A to 1D, the first embodiment of the present invention provides a custom assembly light-emitting module, including: a base unit 1a, a light-emitting unit 2a, a plurality of screw elements 3a, a lens unit 4a, and two cover unit 5a.

The base unit 1a has a heat-dissipating base 10a and two first retaining structures 11a extending upwards from two opposite lateral sides of the heat-dissipating base 10a. Each first retaining structure 11a has a concave retaining portion 110a formed on its outside. In addition, the heat-dissipating base 10a has a plurality of heat-dissipating fins 100a disposed on its bottom portion. However, the type of the heat-dissipating fins 100a is just an example. The shape, the arrangement, the size and the number of the heat-dissipating fins 100a are changeable according to different design requirements. Hence, the present invention can choose different heat-dissipating bases according to different heat-dissipating requirements the user's requirement.

The light-emitting unit 2a has a substrate 20a and a plurality of light-emitting elements 21a electrically disposed on the substrate 20a. The substrate 20a has a plurality of through holes 200a corresponding to the screw elements 3a, and one part of each screw element 3a passes through the corresponding through hole 200a so as to fix the substrate 20a on the heat-dissipating base 10a. In addition, the first embodiment further includes a fine layer of heat-conducting glue A disposed between the heat-dissipating base 10a and the substrate 20a by coating or printing; Alternatively, the first embodiment further includes a heat-conducting piece (not shown) glued between the heat-dissipating base 10a and the substrate 20a, so as to increase the heat-dissipating efficiency of transmitting heat from the light-emitting unit 2a to the heat-dissipating base 10a. However, using the screw elements 3a to fix the substrate 20a on the heat-dissipating base 10a is just an example. Any method for fixing the substrate 20a on the heat-dissipating base 10a is protected in the present invention. In other words, the light-emitting unit 2a can be detachably disposed on the heat-dissipating base 10a by any assembly method. Hence, the space, the color, the number and the power of the light-emitting elements 21a can be changed according to user's requirement.

The lens unit 4a has a lens 40a and two second retaining structures 41a formed on two opposite lateral sides of the lens 40a. The two retaining structures 41a correspond to the two first retaining structures 11a respectively. Hence, the lens unit 4a is detachably disposed over the light-emitting unit 2a by matching the two first retaining structures 11a and the two second retaining structures 41a. In the first embodiment, the two first retaining structures 11a are two first sliding grooves facing each other, the two second retaining structures 41a are two second sliding grooves in opposite direction to each other, the two first sliding grooves and the two second sliding grooves are slidably matched with each other. However, the match between the two first sliding grooves and the two second sliding grooves is just an example. The lens unit 4a can be detachably disposed over the light-emitting unit 2a by any matching method.

The two cover units 5a are respectively covering two opposite lateral sides of the base unit 1a. Each cover unit 5a has a cover body 50a and a protruding portion 51a projecting from the cover body 50a and fitted tightly between the two first retaining structures 11a.

Referring to FIG. 1C, the light beams S generated by the light-emitting elements 21a pass through the lens 40a and generate projecting light beams P1 with predetermined light-projecting angles. Hence, the lens 40a can be changed according to the different light-projecting angles the user's requirement.

Referring to FIG. 1D, the base unit 1a is inverted and retained in a hooking unit 6a by the two concave retaining portions 110a mating with the hooking unit 6a. For example, when a user wants to place the custom assembly light-emitting module of the present invention on a ceiling (or on a wall or on any object), the base unit 1a can be inverted and retained between two hooking structures 60a of the hooking unit 6a by matching the two concave retaining portions 110a and the hooking structures 60a on the ceiling. The heat-dissipating base 10a is hidden in the hooking unit 6a, and the lens 40a is exposed out of the hooking unit 6a. Hence, the light beams S generated by the light-emitting elements 21a pass through the lens 40a and generate upwards projecting light beams P1 with predetermined light-projecting angles so as to provide brightness the user's requirement. In addition, the present invention can generate different light-projecting angles due to the replacement of the lens 40a.

Referring to FIG. 1E, the difference between FIG. 1E and FIG. 1C is that: the lens 40a has been replaced by another lens L in FIG. 1E. Hence, the light beams S generated by the light-emitting elements 21a pass through the lens L and generate projecting light beams P2 with another predetermined light-projecting angle.

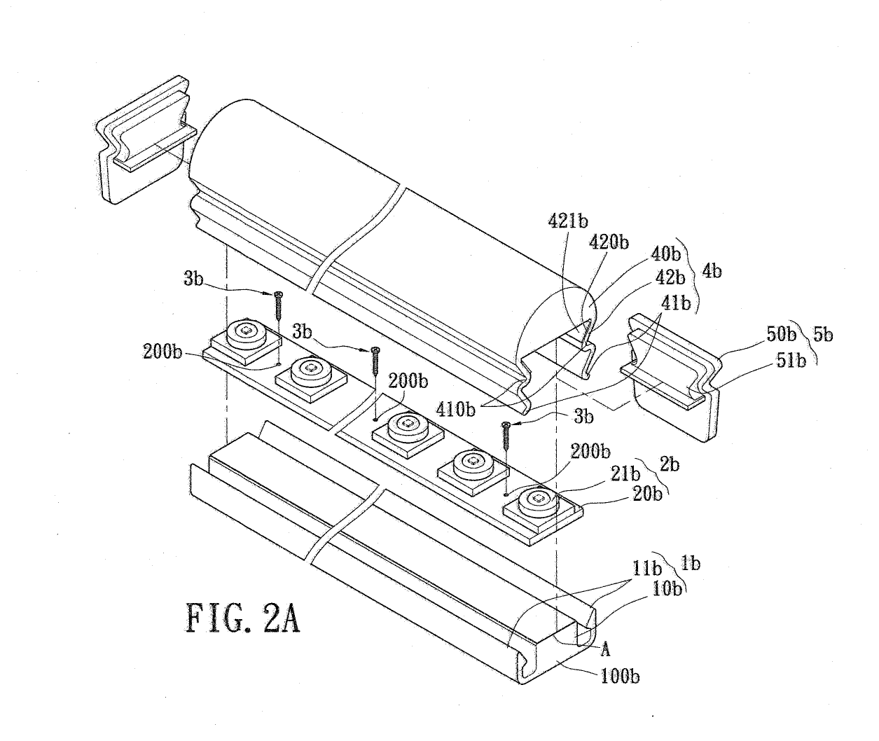

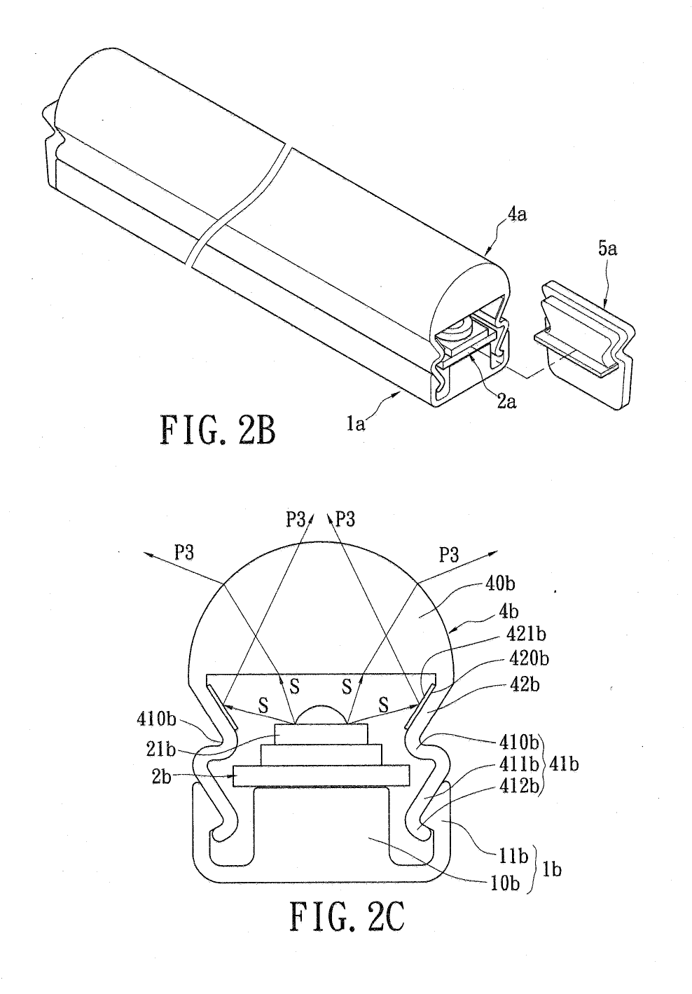

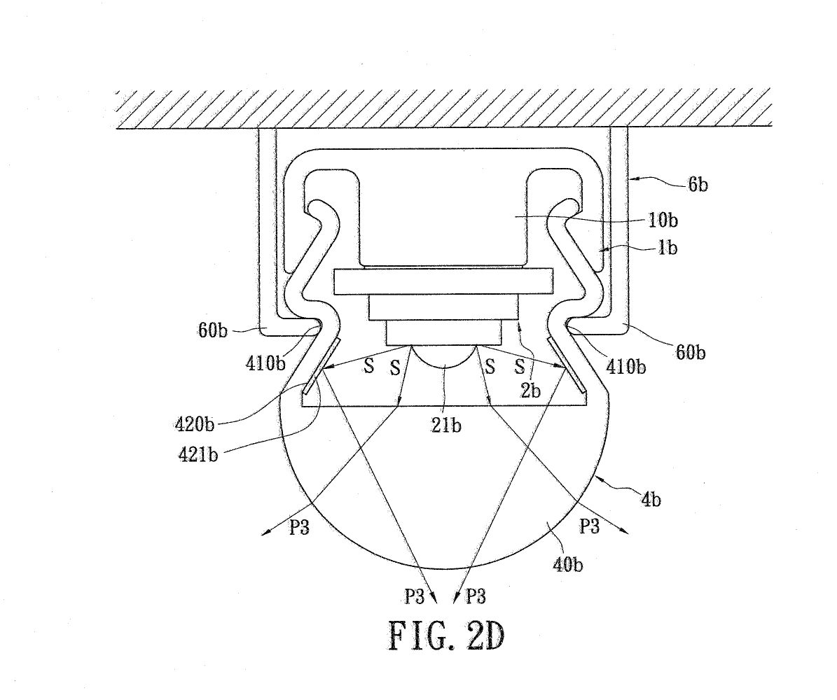

Referring to FIGS. 2A to 2D, the second embodiment of the present invention provides a custom assembly light-emitting module, including: a base unit 1b, a light-emitting unit 2b, a plurality of screw elements 3b, a lens unit 4b, and two cover unit 5b.

The base unit 1b has a heat-dissipating base 10b and two first retaining structures 11b formed on two opposite lateral sides of the heat-dissipating base 10b. In addition, the heat-dissipating base 10b has a plurality of heat-dissipating fins or a heat-dissipating body 1001) disposed on its bottom portion. However, the type of the heat-dissipating body 100b is just an example. The shape, the arrangement, the size and the number of the heat-dissipating fins are changeable according to different design requirements. Hence, the present invention can choose different heat-dissipating bases according to different heat-dissipating requirements the user wants.

The light-emitting unit 2b has a substrate 20b and a plurality of light-emitting elements 21b electrically disposed on the substrate 20b. The substrate 20b has a plurality of through holes 200b corresponding to the screw elements 3b, and one part of each screw element 3b passes through the corresponding through hole 200b so as to fix the substrate 20b on the heat-dissipating base 10b. In addition, the second embodiment further includes a fine layer of heat-conducting glue A disposed between the heat-dissipating base 10b and the substrate 20b by coating or printing; Alternatively, the second embodiment further includes a heat-conducting piece (not shown) glued between the heat-dissipating base 10b and the substrate 20b, so as to increase the heat-dissipating efficiency of transmitting heat from the light-emitting unit 2b to the heat-dissipating base 10b. However, using the screw elements 3b to fix the substrate 20b on the heat-dissipating base 10b is just an example. Any method for fixing the substrate 20b on the heat-dissipating base 10b is protected in the present invention. In other words, the light-emitting unit 2b can be detachably disposed on the heat-dissipating base 101) by any assembly method. Hence, the space, the color, the number and the power of the light-emitting elements 21b can be changed according to user's requirement.

The lens unit 4b has a lens 40b, two reflected portions 42b extending downwards from two opposite lateral sides of the lens 40b and two second retaining structures 41b respectively extending downwards from the two reflected portions 42b. The two second retaining structures 41b correspond to the two first retaining structures 11b respectively.

Each reflected portion 42b has an inclined surface 420b formed on an inner wall thereof and a reflective layer 421b formed on each inclined surface 420b, and the two inclined surfaces 420b of the two reflected portions 42b face each other and are disposed beside two opposite lateral sides of the light-emitting unit 2b. In addition, the two reflected portions 42b and the two second retaining structures 41b are light-transmitting substances.

Furthermore, each reflected portion 42b is extended obliquely from the lens 40b, and each second retaining structure 41b has a top bending portion 410b bent downwards from each reflected portion 42b, an extending portion 411b extended obliquely from the top bending portion 410b, and a bottom bending portion 412b bent downwards from the extending portion 411b. In addition, each top bending portion 410b has an S shape, and each bottom bending portion 412b has an L shape.

Hence, the lens unit 4b is detachably mated with the base unit 1b by slidably engaging the two first retaining structures 11b respectively with the two second retaining structures 41b. In the second embodiment, the two first retaining structures 11b are two first sliding grooves facing each other, the two second retaining structures 41b are two second sliding grooves in opposite direction to each other, the two first sliding grooves and the two second sliding grooves are slidably matched with each other. However, the match between the two first sliding grooves and the two second sliding grooves is just an example. The lens unit 4b can be detachably disposed over the light-emitting unit 2b by any matching method.

The two cover units 5b are respectively covering two opposite lateral sides of the base unit 1b. Each cover unit 5b has a cover body 50b and a protruding portion 51b projecting from the cover body 50b and fitted tightly between the two second retaining structures 41b.

Referring to FIG. 20, the light beams S generated by the light-emitting elements 21b pass through the lens 40b and generate projecting light beams P3 with predetermined light-projecting angles. In addition, one part of light beams S generated by the light-emitting elements 21b are reflected by the two reflective layers 421b. Hence, the lens 40b is changeable according to the different light-projecting angles that the user wants.

Referring to FIG. 2D, the lens unit 4b is inverted and retained under a hooking unit 6b by the two top bending portions 410b matching with the hooking unit 6b. For example, when a user wants to place the custom assembly light-emitting module of the present invention on a ceiling (or on a wall or on any object), the base unit 1b can be inverted and retained between two hooking structures 60b of the hooking unit 6b by matching the two top bending portions 410b and the hooking structures 60b on the ceiling. The heat-dissipating base 10b is hidden in the hooking unit 6b, and the lens 40b is exposed out of the hooking unit 6b. Hence, the light beams S generated by the light-emitting elements 21b pass through the lens 40b and generate upwards projecting light beams P3 with predetermined light-projecting angles so as to provide brightness the user's requirement. In addition, the present invention can generate different light-projecting angles due to the replacement of the lens 40b.

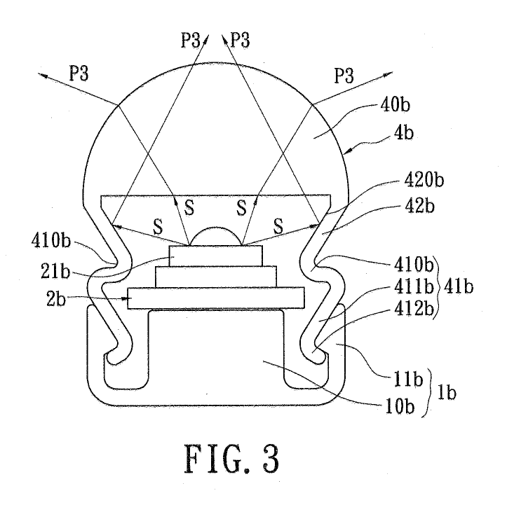

Referring to FIG. 3, the two reflected portions 42b and the two second retaining structures 41b are opaque substances, so that one part of light beams S generated by the light-emitting elements 21b are reflected by the two inclined surfaces 420b without using the reflective layers 421b as shown in FIG. 2C.

In conclusion, the base unit of the present invention is replaceable according to different heat-dissipating effects, the light-emitting unit of the present invention is replaceable according to different light-emitting effects, and the lens unit of the present invention is replaceable according to different light-projecting angles.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A custom assembly light-emitting module, comprising:
a base unit having a heat-dissipating base and two first retaining structures formed on two opposite lateral sides of the heat-dissipating base;
a light-emitting unit detachably disposed on the heat-dissipating base; and
a lens unit having a lens, two reflected portions extending downwards from two opposite lateral sides of the lens and two second retaining structures respectively extending downwards from the two reflected portions, wherein the lens unit is detachably mated with the base unit by slidably engaging the two first retaining structures respectively with the two second retaining structures;
wherein each reflected portion has an inclined surface formed on an inner wall thereof, and the two inclined surfaces of the two reflected portions face each other and are disposed beside two opposite lateral sides of the light-emitting unit, so that one part of light beams generated by the light-emitting unit are reflected by the two inclined surfaces.

2. The custom assembly light-emitting module as claimed in claim 1, wherein the heat-dissipating base has a heat-dissipating body disposed on its bottom portion.

3. The custom assembly light-emitting module as claimed in claim 1, wherein the light-emitting unit has a substrate and a plurality of light-emitting elements electrically disposed on the substrate.

4. The custom assembly light-emitting module as claimed in claim 3, further comprising: a plurality of screw elements, wherein the substrate has a plurality of through holes corresponding to the screw elements, and one part of each screw element passes through the corresponding through hole so as to fix the substrate on the heat-dissipating base.

5. The custom assembly light-emitting module as claimed in claim 3, further comprising: a layer of heat-conducting glue or a heat-conducting piece disposed between the heat-dissipating base and the substrate.

6. The custom assembly light-emitting module as claimed in claim 1, wherein the two first retaining structures are two first sliding grooves facing each other, the two second retaining structures are two second sliding grooves in opposite direction to each other, and the two first sliding grooves and the two second sliding grooves are slidably matched with each other.

7. The custom assembly light-emitting module as claimed in claim 1, wherein each reflected portion is extended obliquely from the lens, and each second retaining structure has a top bending portion bent downwards from each reflected portion, an extending portion extended obliquely from the top bending portion, and a bottom bending portion bent downwards from the extending portion.

8. The custom assembly light-emitting module as claimed in claim 7, wherein each top bending portion has an S shape, and each bottom bending portion has an L shape.

9. The custom assembly light-emitting module as claimed in claim 7, wherein the lens unit is inverted and retained under a hooking unit by the two top bending portions mating with the hooking unit.

10. The custom assembly light-emitting module as claimed in claim 1, further comprising: two cover units respectively covering two opposite lateral sides of the base unit.

11. The custom assembly light-emitting module as claimed in claim 10, wherein each cover unit has a cover body and a protruding portion projecting from the cover body and fitted tightly between the two second retaining structures.

12. The custom assembly light-emitting module as claimed in claim 1, wherein each reflected portion has a reflective layer formed on each inclined surface.

13. The custom assembly light-emitting module as claimed in claim 1, wherein the two reflected portions and the two second retaining structures are light-transmitting substances.

14. The custom assembly light-emitting module as claimed in claim 1, wherein the two reflected portions and the two second retaining structures are opaque substances.
